(19) United States
(12) Patent Application Publication
(10) Pub. No.: US 2024/0202545 A1
(43) Pub. Date: Jun. 20, 2024

(54) AN EAGER SAT-BASED SOLVER FOR A QUANTIFIER-FREE THEORY OF STRINGS AND BIT VECTORS

(71) Applicant: Amazon Technologies, Inc., Seattle, WA (US)

(72) Inventors: Kevin LOTZ, Kiel (DE); Bruno DUTERTRE, Mountain View, CA (US); John Byron COOK, Brooklyn, NY (US); Amit GOEL, Portland, OR (US); Robert JONES, Beaverton, OR (US); Benjamin KIESL-REITER, Munich (DE); Soon Ho KONG, Cupertino, CA (US); Rupak MAJUMDAR, Krickenbach (DE)

(73) Assignee: Amazon Technologies, Inc., Seattle, WA (US)

(21) Appl. No.: 18/066,881

(22) Filed: Dec. 15, 2022

(51) Int. Cl. G06N 5/01; G06N 5/04

(52) U.S. Cl. CPC G06N 5/013; G06N 5/04

(57) ABSTRACT

Techniques are described for providing a SAT-based solver for a quantifier-free theory of strings and bit vectors. The solver can be used by an automated reasoning service of a cloud provider network to analyze policies and the consequences of policies. The solver reduces an input formula to a Boolean satisfiability problem by encoding the input formula into an equisatisfiable propositional formula, where the satisfiability of the equisatisfiable propositional formula is determined by a SAT solver. Rather than using a traditional DPLL(T) style algorithm, the solver described herein bounds the length of variables in an input formula and reduces the problem to a single formula, which can then be solved using incremental SAT solving. The solver can be used independently or as part of a portfolio of solvers used to determine the satisfiability or unsatisfiability of certain formula corresponding, e.g., to questions about users' policies within a cloud provider network.

### BACKGROUND

Cloud provider networks enable users to use a variety of computing-related resources such as compute resources, storage resources, networking resources, and the like. When a user or application interacts with a cloud provider network (e.g., using an application programming interface (API) or command line interface (CLI) provided by the cloud provider network), the user or application typically is required to specify security credentials to indicate who the user or application is and whether the user or application has permission to access the requested resources. A cloud provider network in turn uses the security credentials to authenticate and authorize the user or application to perform various actions. Access to resources and actions within a cloud provider network may be further managed by policies. A policy is a data object that, when associated with a user or resource, defines its permissions. For example, resource-based policies can be attached to a storage resource, compute instance, encryption keys, etc., and can specify who has access to the resource and what actions those identities can perform on the resource.

### BRIEF DESCRIPTION OF DRAWINGS

Various examples in accordance with the present disclosure will be described with reference to the drawings, in which:

FIG. 1 is a diagram illustrating a computing environment including a solver for a quantifier-free theory of strings and bit vectors used to analyze policies within a cloud provider network according to some examples.

FIG. 2 is a diagram illustrating the generation of a formula expressed in first-order logic corresponding to a policy question involving a policy managed by an identity and access management service of a cloud provider network according to some examples.

FIG. 3 is a diagram illustrating the use of a solver for a quantifier-free theory of strings and bit vectors to automate reasoning about policies and the consequences of policies of a cloud provider network according to some examples.

FIG. 4 is a diagram illustrating the generation of a Boolean abstraction of an input formula used by the solver according to some examples.

FIG. 5 is a flow diagram illustrating operations of a method for using a SAT-based solver for a quantifier-free theory of strings and bit vectors to analyze policies the consequences of policies of a cloud provider network according to some examples.

FIG. 6 illustrates an example provider network environment according to some examples.

FIG. 7 is a block diagram of an example provider network that provides a storage service and a hardware virtualization service to customers according to some examples.

FIG. 8 is a block diagram illustrating an example computer system that can be used in some examples.

### DETAILED DESCRIPTION

The present disclosure relates to methods, apparatus, systems, and non-transitory computer-readable storage media for providing a SAT-based solver for a quantifier-free theory of strings and bit vectors. According to some examples, the solver can be used by an automated reasoning service of a cloud provider network to analyze policies and the consequences of policies within a provider network (e.g., policies defining what actions certain principals can or cannot perform relative to certain cloud-based resources). As described in more detail herein, the solver reduces an input formula (e.g., a formula expressing question about one or more policies) to a Boolean satisfiability problem by encoding the input formula into an equisatisfiable propositional formula, where the satisfiability of the equisatisfiable propositional formula is determined by a SAT solver. Rather than using a traditional DPLL(T) style algorithm, the solver described herein bounds the length of string variables in an input formula and reduces the problem to a single propositional formula, which can then be solved using incremental SAT solving. The solver can be used independently or as part of a portfolio of solvers used to determine the satisfiability or unsatisfiability of certain formula corresponding, e.g., to questions about users' policies within a cloud provider network.

As part of the computing-related services provided by cloud provider networks, many cloud providers offer identity and access management services. These services generally help users to control access and permissions to the services and resources (e.g., compute instances, storage resources, etc.) provided to users of a cloud provider network. By using identity-based and resource-based policies, for example, users can granularly control which identities (e.g., users or roles) are able to access specific resources associated with the users' accounts and how those identities can use the resources. The configuration of such policies can often become quite complex, and it is thus often challenging for users to understand all the implications of such policies and their interrelationships (e.g., whether the policies may unintentionally permit any undesirable security- or operational-related actions on users' resources).

To alleviate some of these concerns, a cloud provider network may provide tools that help users analyze the characteristics of the resources and associated policies within their accounts. One example of such a security tool is an access analyzer, which can help users understand which identities can access certain resources associated with their account and, based on such information, help users identify whether their current policy configurations potentially provide unintended access to users outside of their organization. In this example, an access analyzer service may perform such analyses in part by translating a users' or organizations' stored policies into equivalent logical statements (e.g., statements expressed in a first order logic) and use a suite of general-purpose and specialized logical solvers (e.g., satisfiability modulo theories (SMT) solvers) to verify whether certain security-related behaviors are possible or not. In this context, the logical solvers reason about propositional logic statements including various string variables, e.g., corresponding to aspects of policies such as account identifiers, resource identifiers, and the like. In addition to identity and access management services, some cloud provider networks also provide source code review and optimization services, program or computer network verification services, among other types of services that use automated reasoning to help analyze the correctness of various types of computing systems.

Satisfiability problems, or SAT, ask whether it's possible to assign variables values (e.g., true or false) that satisfy a set of constraints. The SMT solvers described above generally attempt to prove or disprove formulae expressed in first-order logic with combinations of theories such as Presburger arithmetic, uninterpreted functions, or strings. As indicated, an automated reasoning service can take as input a policy and a question, translate the policy and question into an SMT query, and call a portfolio solver to obtain an answer. A portfolio solver invokes multiple solvers in the backend and returns a result from the solver that comes back with an answer first. By leveraging the diversity of such solvers, each of which may be more efficient than the others at analyzing certain types of policies and questions, an automated reasoning service can typically solve queries more quickly. However, even with a diversity of solvers, automated reasoning services can nevertheless fail to provide answers efficiently for certain types of problems. The addition of additional solvers that can solve different subsets of such problems can thus improve the overall efficiency of these automated reasoning services.

According to embodiments described herein, a new solver is proposed that efficiently solves at least a subset of policy questions as described above in part by using bounded model checking techniques for strings, among other techniques. As described in more detail herein, the solver initially creates an abstraction (e.g., a Boolean skeleton) of the input formula. The solver then bounds the lengths of string variables contained in the input formula and encodes the input formula into an equisatisfiable propositional formula with respect to the established upper bounds for the string variables. By reducing an input SMT formula to a single propositional formula, which can be solved using incremental SAT solving, many types of policy-related questions expressed in first order logic can be solved more efficiently, thereby helping to provide answers to users' questions about their policies and to help users of a cloud provider network optimize their access policies, among other benefits.

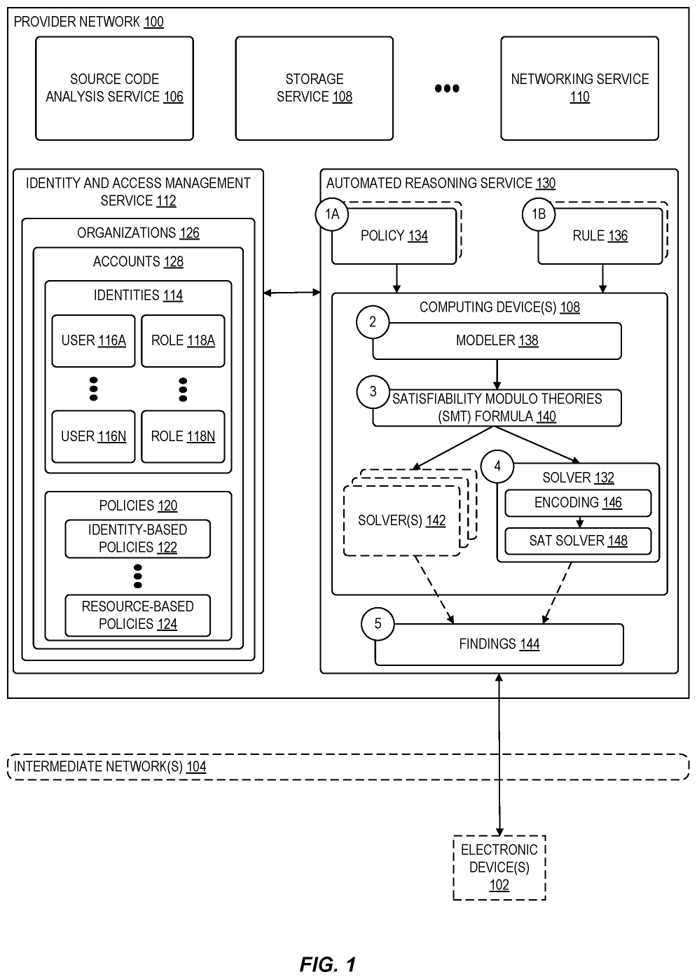

FIG. 1 is a diagram illustrating an environment including an automated reasoning service used to analyze policies associated with user accounts and organizations of user accounts of a cloud provider network according to some examples. A provider network 100 (or, “cloud” provider network) provides users with the ability to use one or more of a variety of types of computing-related resources such as compute resources (e.g., executing virtual machine (VM) instances and/or containers, executing batch jobs, executing code without provisioning servers). data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of provider networks 100 can use one or more user accounts that are associated with a customer account, though these terms can be used somewhat interchangeably depending upon the context of use. Users can use one or more electronic device(s) 102 to interact with a provider network 100 across one or more intermediate networks 104 (e.g., the internet) via one or more interfaces, such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context. APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the provider network 100 that includes “backend” services supporting and enabling the services that can be more directly offered to customers.

For example, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

A cloud provider network 100 can be formed as a collection of regions, where a region is a geographical area in which the cloud provider clusters data centers. Each region includes multiple (e.g., two or more) availability zones (AZs) connected to one another via a private high-speed network, for example a fiber communication connection. An AZ (also known as a “zone”) provides an isolated failure domain including one or more data center facilities with separate power, separate networking, and separate cooling from those in another AZ. A data center refers to a physical building or enclosure that houses and provides power and cooling to servers of the cloud provider network. Preferably, AZs within a region are positioned far enough away from one another so that a natural disaster (or other failure-inducing event) should not affect or take more than one AZ offline at the same time.

Users can connect to an AZ of the cloud provider network via a publicly accessible network (e.g., the Internet, a cellular communication network), e.g., by way of a transit center (TC). TCs are the primary backbone locations linking users to the cloud provider network and can be collocated at other network provider facilities (e.g., Internet service providers (ISPs), telecommunications providers) and securely connected (e.g., via a VPN or direct connection) to the AZs. Each region can operate two or more TCs for redundancy. Regions are connected to a global network which includes private networking infrastructure (e.g., fiber connections controlled by the cloud provider) connecting each region to at least one other region. The cloud provider network can deliver content from points of presence (or “POPs”) outside of, but networked with, these regions by way of edge locations and regional edge cache servers. This compartmentalization and geographic distribution of computing hardware enables the cloud provider network to provide low-latency resource access to users on a global scale with a high degree of fault tolerance and stability.

Generally, the traffic and operations of a provider network can broadly be subdivided into two categories: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes user resources that are implemented on the provider network (e.g., computing instances, containers, block storage volumes, databases, file storage). Data plane traffic generally includes non-administrative operations, such as transferring user data to and from the user resources. The control plane components are typically implemented on a separate set of servers from the data plane servers. and control plane traffic and data plane traffic can be sent over separate/distinct networks.

To provide these and other computing resource services, provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code—typically without the user having any control of or knowledge of the underlying compute instance(s) involved.

As described herein, one type of service that a provider network may provide may be referred to as a “managed compute service” that executes code or provides computing resources for its users in a managed configuration. Examples of managed compute services include, for example, an on-demand code execution service, a hardware virtualization service, a container service, or the like.

An on-demand code execution service (referred to in various examples as a function compute service, functions service, cloud functions service, functions as a service, or serverless computing service) can enable users of the provider network 100 to execute their code on cloud resources without having to select or manage the underlying hardware resources used to execute the code. For example, a user can use an on-demand code execution service by uploading their code and use one or more APIs to request that the service identify, provision, and manage any resources required to run the code. Thus, in various examples, a “serverless” function can include code provided by a user or other entity—such as the provider network itself—that can be executed on demand. Serverless functions can be maintained within the provider network by an on-demand code execution service and can be associated with a particular user or account or can be generally accessible to multiple users/accounts. A serverless function can be associated with a Uniform Resource Locator (URL). Uniform Resource Identifier (URI), or other reference, which can be used to invoke the serverless function. A serverless function can be executed by a compute resource, such as a virtual machine, container, etc., when triggered or invoked. In some examples. a serverless function can be invoked through an application programming interface (API) call or a specially formatted HyperText Transport Protocol (HTTP) request message. Accordingly, users can define serverless functions that can be executed on demand, without requiring the user to maintain dedicated infrastructure to execute the serverless function. Instead, the serverless functions can be executed on demand using resources maintained by the provider network 100. In some examples, these resources can be maintained in a “ready” state (e.g., having a pre-initialized runtime environment configured to execute the serverless functions), allowing the serverless functions to be executed in near real-time.

A hardware virtualization service (referred to in various implementations as an elastic compute service, a virtual machines service, a computing cloud service, a compute engine, or a cloud compute service) can enable users of the provider network 100 to provision and manage compute resources such as virtual machine instances. Virtual machine technology can use one physical server to run the equivalent of many servers (each of which is called a virtual machine). for example using a hypervisor, which can run at least on an offload card of the server (e.g., a card connected via PCI or PCle to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

Another type of managed compute service can be a container service, such as a container orchestration and management service (referred to in various implementations as a container service, cloud container service, container engine, or container cloud service) that allows users of the cloud provider network to instantiate and manage containers. In some examples the container service can be a Kubernetes-based container orchestration and management service (referred to in various implementations as a container service for Kubernetes, Azure Kubernetes service, IBM cloud Kubernetes service, Kubernetes engine, or container engine for Kubernetes). A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). While multiple virtual machines can run on one physical machine, each virtual machine typically has its own copy of an operating system, as well as the applications and their related files, libraries, and dependencies. Some containers can be run on instances that are running a container agent, and some containers can be run on bare-metal servers, or on an offload card of a server. As indicated, a provider network 100 can further include a wide range of additional services such as a source code analysis service 106, a storage service 108, a networking service 110, and the like.

In some examples, an identity and access management service 112 is a service that enables users to securely control access to cloud provider network resources (e.g., computing resources associated with various provider network services, such as storage objects associated with a storage service 108, databases associated with a database service, compute instances associated with a hardware virtualization service, and the like). The identity and access management service 112 is broadly used to control who is permitted to authenticate (e.g., sign in) with the cloud provider network 100 and who is authorized (e.g., has permissions) to use resources provided by the cloud provider network 100. In general, a resource is a concept used to capture the domain of items that can be created, read, modified, or deleted by customers in a cloud provider network 100. Examples of resources also include identities (e.g., identities 114, including example users 116A, . . . , 116N and roles 118A, . . . , 118N) and policies 120 (e.g., including identity-based policies 122, resource-based policies 124, among other possible types of policies). FIG. 1 further illustrates the concept of an organization 126, which can include any number of associated accounts 128, which can further include any number of users and roles.

When a person initially creates an account with the cloud provider network 100, the person may begin with a single sign-in identity that has complete access to all cloud provider network services and resources associated with the account (e.g., a root user of identities 114). For example, the root user identity may be accessed by signing in with a username (e.g., an email address) and a password used to create the account. Cloud provider networks 100 often advise users not to use a root user for most tasks and instead to create additional user accounts with defined permissions. A user can grant different permissions to different user accounts for different resources. For example, one user account might be configured to allow some users complete access to a hardware virtualization service, a storage service 108, and other cloud provider network 100 resources. For other users, a user account might allow read-only access to some storage buckets, or permission to administer some instances, etc.

In some examples, a principal represents a person or application that can make a request for an action or operation on a resource of the cloud provider network 100 via one or more identities, although sometimes the term principal can be used interchangeably with an identity. The set of identities 114 associated with an account 128 can include any number of users and roles. A cloud provider network request occurs when a principal uses an identity (e.g., a user or a role) to send a request for an action or operation on a resource. A request can include some or all of the following information: the action or operations that the principal wants to perform, the resource object upon which the actions or operations are performed, the person or application that used an identity (e.g., a user or role) to send the request, environment data (e.g., information about the IP address, user agent. SSL enabled status, time of day, etc.), and resource data (e.g., data related to the resource that is being requested, such as a resource identifier, or a tag name). In some examples, the identity and access management service 112 gathers the information contained in a request into a request context, which is used to evaluate and authorize the request.

For some requests to be completed, the identity and access management service 112 determines whether the requesting principal is authorized (e.g., permitted) to complete the request. During authorization, the identity and access management service 112 uses values included in the request context to check for policies that apply to the request. The identity and access management service 112 uses the identified policies to determine whether to allow or deny the request. In some examples, the policies are stored by the identity and access management service 112 as JavaScript Object Notation (JSON) documents (or using any other data format) and specify the permissions for particular identities. In some examples, there are several types of policies 120 that can affect whether a request is authorized including, e.g., identity-based policies 122, trust policies, among other policies. For example, to provide users with permissions to access resources in their own account, identity-based policies can be configured, while resource-based policies may be used for granting cross-account access to resources. In some examples, the identity and access management service 112 checks each policy that applies to the context of a request. If a single permissions policy includes a denied action, the identity and access management service 112 denies the entire request. In some examples, an identity and access management service 112 denies requests by default, such that a request is authorized only if every part of a request is allowed by applicable permissions policies.

Once a request is authenticated and authorized, the identity and access management service 112 approves the actions or operations in the request. Operations are defined by a service and include actions that can be performed on or relative to a resource, such as viewing, creating. editing, and deleting that resource. For example, the identity and access management service 112 may support actions such as CreateUser, DeleteUser, CreateRole, and AssumeRole, among many other possible actions. A hardware virtualization service might support actions such as launching a VM instance, deleting a VM instance, etc. To allow a principal to perform an operation, the action is included in a policy that applies to the principal or the affected resource.

According to examples described herein, a provider network 100 includes an automated reasoning service 130 to enable the analysis of policies and the consequence of policies within a cloud provider network. The automated reasoning service 130 further includes a solver 132 used to improve the service's ability to perform automated reasoning tasks related to policy analysis and other types of problems. The solver 132, as described in more detail hereinafter, is a SAT-based solver for a first-order theory of strings and bit vectors, and can optionally be used as part of a portfolio solver including one or more other solvers 142 (including, e.g., one or more SMT solvers).

As shown in FIG. 1, an automated reasoning service 130 takes as input one or more policies 134 and one or more rules 136 (e.g., no public read/write access should be allowed for storage resources, server-side encryption should be enabled for a storage resource, etc.). For example, can be responsive to a user request to analyze one or more resources and policies, or performed automatically by one or more services of a cloud provider network. As described in more detail hereinafter, the automated reasoning service 130 broadly obtains, at circles “1A” and “1B,” the one or more policies 134 and rules 136, at circle “2” uses a modeler 138 to model the policies 134 and rules 136 as an SMT formula 140 over the theory of strings, and at circle “3,” provides the formula 140 to an solver 132, or a portfolio solver of multiple solvers including solver(s) 142, to determine the satisfiability of the formula at circle “4.” The automated reasoning service 130 uses the result of the solver 132 (or solver(s) 142) to inform a user or other system that the input policy 134 or policies either adheres to the rules 136 or not, illustrated as findings 144. For example, the findings 144 might alert a user that a policy associated with the user permits public write access to a resource, which may be unintended, or the findings 144 might be provided to one or more downstream components that generate alerts, additional analyses, or the like. As shown, the solver 132 broadly includes a process of encoding 146 the SMT formula 140 into an equisatisfiable propositional formula and using a SAT solver 148 to determine whether the encoded formula is satisfiable, the details of which are illustrated in subsequent figures.

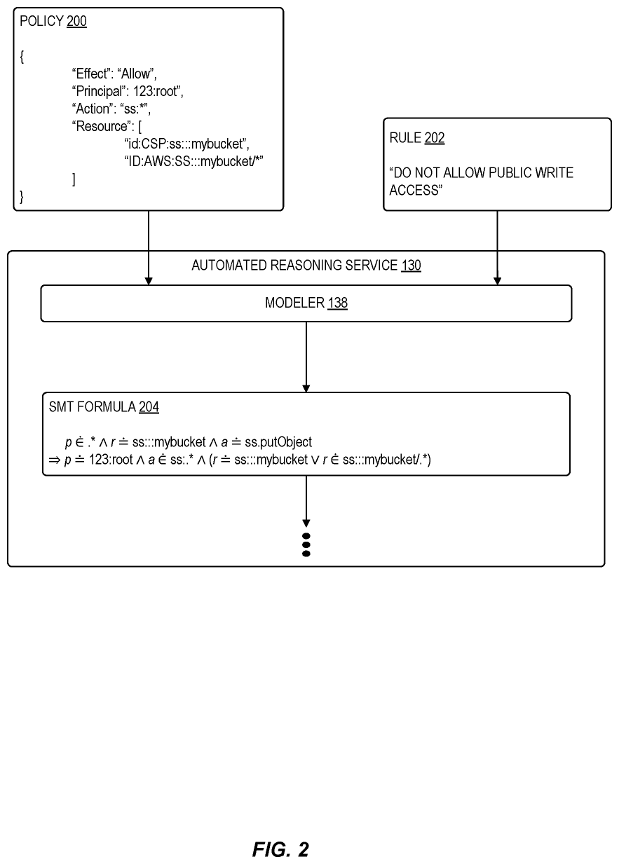

FIG. 2 is a diagram illustrating the generation of a formula expressed in first-order logic corresponding to a policy question involving a policy managed by an identity and access management service of a cloud provider network according to some examples. As shown, the input to a modeler 138 can include one or more policies (e.g., a policy 200 including the illustrated policy snippet) and one or more rules or questions (e.g., a rule 202 indicating a desired condition of the policy 200). In this example, the rule 202 indicates that it is desired for the policy 200 to not allow public write access to any computing resource governed by the policy 200. In general, a question about the desired condition of the policy can include, for example, determining whether public write access is permitted on a computing resource, determining whether unencrypted writes are permitted on a computing resources, determining whether public read access is permitted on a computing resource, or determining whether Secure Socket Layer (SSL) requests are required to access a computing resource, comparing a permissiveness of two policies relative to one another, or the like.

In some examples, the modeler 138 translates the one or more input policies and rules into a formula 204 (or query) involving a theory of strings. The statements can include Boolean combinations (and, or, not), word equations (e.g., x=const., and x=y, where x and y are string variables), and regular constraints. In the example of FIG. 2, the formula 204 is a quantifier-free formula expressed in first-order logic.

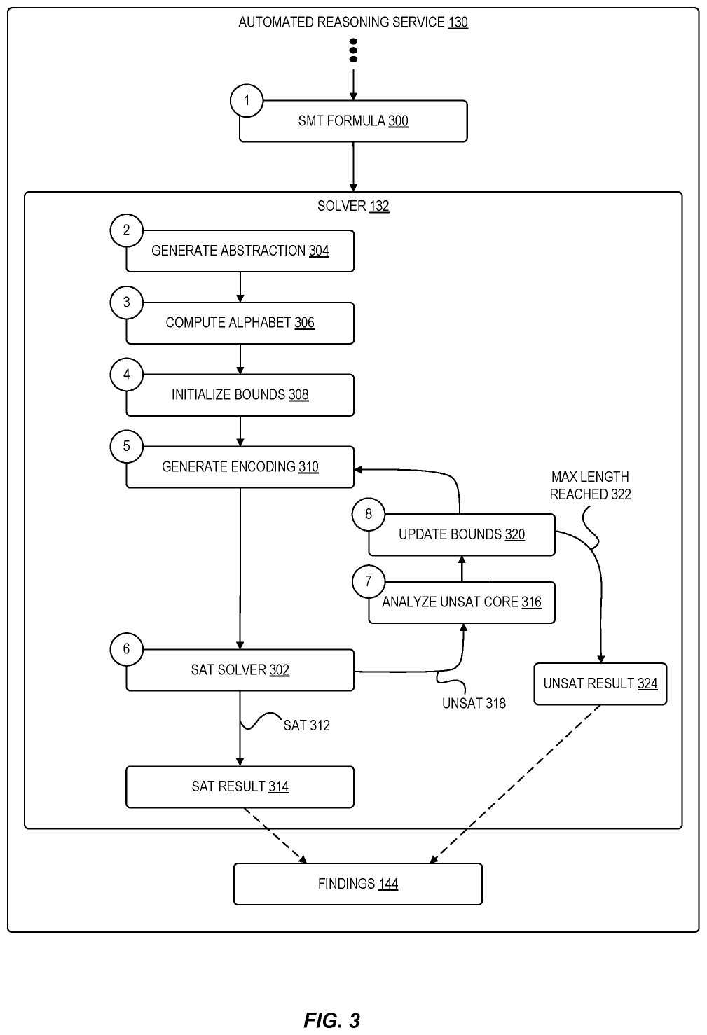

FIG. 3 illustrates the use of a solver for a quantifier-free theory of strings and bit vectors to automate reasoning about policies and the consequences of policies of a cloud provider network according to some examples. Similar to the process described above with respect to FIG. 1, the solver 132 initially obtains, at circle “1” in FIG. 3, an SMT formula 300 that models the relevant input policy or policies and rule or rules to be verified by the solver 132. In contrast to many other types of solvers, the solver 132 solves queries by reduction to the Boolean satisfiability problem, which encodes the formula 300 into a propositional formula and uses a SAT solver 302 to search through the space of substitutions for a solution.

In some examples, a solver 132 supports input formulas from the following syntax:

F:=F∨|F∧F|¬F|Atom|χ_{B}

Atom=χₛₜᵣ ∈ RE|tₛₜᵣ≐χₛₜᵣ|χₛₜᵣ≐cₛₜᵣ|cₛₜᵣ\dot{⊏}χₛₜᵣ|cₛₜᵣ\dot{⊐}χₛₜᵣ

RE:=RE∪RE|RE·RE|RE*|RE∩RE|?|cₛₜᵣ

χₛₜᵣ:=χ, with χ ∈ Γ

cₛₜᵣ:=c, with χ ∈ Σ*

In the example syntax above, [symbol] refers to an arbitrary Boolean variable and ‘?’ denotes the regular wildcard character, which accepts any symbol of the alphabet.

At circle “2” in FIG. 3, the solver 132 initially abstracts 304 the input formula 300 by replacing each atomic formula (or “theory atom,” or simply “atom”) within the input formula 300 by a new Boolean variable. In general, the solver 132 processes the input formula 300 and, each time the solver encounters a new theory atom that the solver 132 has not yet encountered, the solver creates a new Boolean variable and replaces the atom with the Boolean variable.

The result of this abstraction process 304 is a Boolean abstraction of the input formula 300 and a set of definitions in the theory expressed as equivalences. In some examples, the definitions are encoded based on ideas related to the Plaisted-Greenbaum transformation. By encoding the definitions in this manner, for example, the solver 132 often can consider only one direction of a definition/equivalence (e.g., a single implication d(a)→a or ¬d(a)→¬a) instead of both directions.

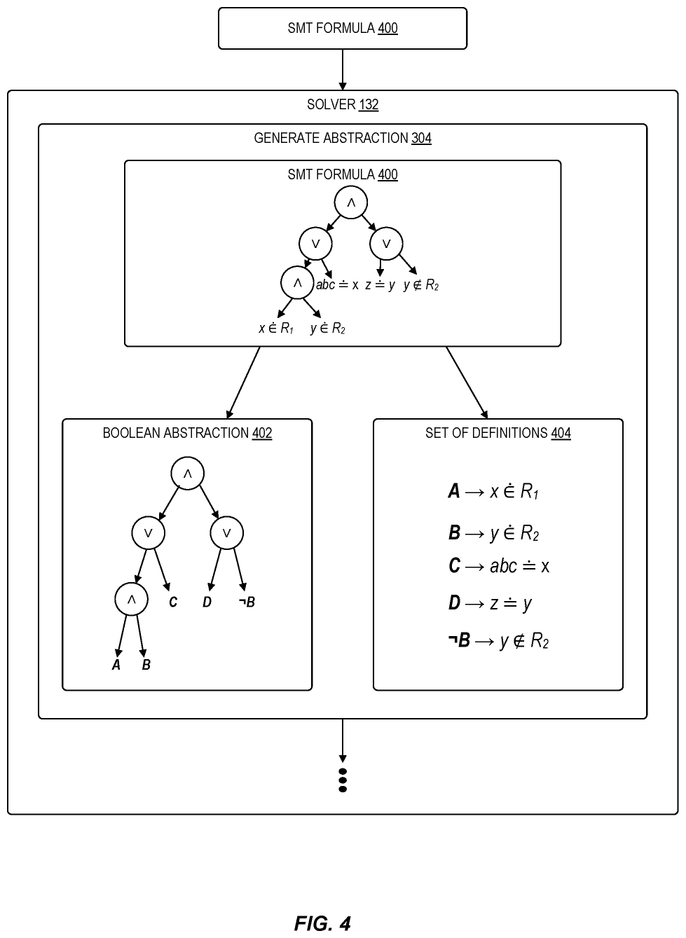

FIG. 4 is a diagram illustrating the generation of a Boolean abstraction of an input formula analyzed by a solver according to some examples. As shown in FIG. 4, the generate abstraction 304 process begins with an input SMT formula 400 expressed, e.g., in negation normal form and, based on the formula, the solver 132 generates a Boolean abstraction 402 of the input formula and a set of definitions 404. Each variable in the Boolean abstraction 402 represents a constraint on one or more string variables, as shown in the set of definitions 404. The original SMT formula 400 is equisatisfiable to the conjunction of the Boolean abstraction 402 and the conjunction of the set of definitions 404.

Returning to FIG. 3, at circle “3,” the solver 132 determines an alphabet 306 to use during the remainder of the solving process. An SMT solver for formulas including string variables, for example, typically uses Unicode for possible interpretations of the string variables included in the analyzed formulas. However, a significantly smaller alphabet (e.g., one containing less than all the possible Unicode characters) is typically sufficient for the solver 132 to use in the context of analyzing policies. In some examples, the solver 132 determines the alphabet to be used during solving by identifying the set of characters occurring in the problem (e.g., a set of characters occurring in one or more of the input policy or policies, rules, and resulting formula) and adding one additional character per string variable in the formula 300. In some examples, a separate alphabet can be computed and used for each string variable in the formula 300, e.g., based on analyzing the characters occurring in association with each string variable in the formula.

For example, satisfiability is kept when fixing a distinct alphabet per congruent closure in a conjunctive normal formula, and adding one unused extra character if there is a disequality to another closure. Since at most every equality in a formula holds, the alphabet of a closure in any satisfying assignment is a subset of the alphabet of the closure where all equalities are satisfied. Thus, the solver 132 calculates the alphabets based on an assumption that all equalities in a formula are satisfied and adds a single extra character per variable.

In some examples, at circle “4” in FIG. 3, the solver 132 determines 308 initial bounds for the string variables in the formula 300. While, in theory, a substitution for a string variable can be of arbitrary length, a finite propositional formula can only encode a bounded number of substitutions. By bounding the length of each string variable in the formula 300, the solver 132 can reduce the formula to a propositional formula and provide the propositional formula as input to a SAT solver. The initial bounded length assigned to each string variable can be based on information about the string variable in the formula—for example, if a string variable x is based at least in part on the constraint “abc*”, then any valid assignment to the variable x includes at least three characters (i.e., the characters “abc”). More generally, if a constraint involving a string variable requires some substring to be contained in any solution, then the length of the string variable has to be at least the length of the substring. These and other observations can be used by the solver 132 to determine a minimum initial bound for each of the string variables in the formula 300. In some examples, a user can provide an initial bound to use as input to the solver 132 as part of invoking the solver 132 to analyze a formula (e.g., provided as input to an automated reasoning service 130 or directly to the solver 132).

At circle “5,” in some examples, the solver 132 encodes 310 the set of definitions in propositional logic with respect to the upper bounds for each string variable determined above. For example, referring again to FIG. 4, the solver 132 encodes definitions (e.g., a set of definitions 404), each of which may include one or more string variables, into propositional logic statements based on a bounded length determined for each of the string variables (e.g., the string variables “x”, “y”, and “z” in the set of definitions 404). To do so, the solver 132 treats the string variables as sequences of characters of length n, where n represents the bounded length value determined for a variable (and where each string variable can be associated with a same or different bounded length). Each round of encoding results in an incremental call to the SAT solver 302 until, in round N, the solver 132 determines that the encoding with respect to the current length bounds is satisfiable or it is unsatisfiable, even if the solver 132 increases the bounds further.

For example, the encoding process broadly involves translating the definitions of the Boolean abstraction (e.g., the set of definitions 404) into propositional formulas that are satisfiable if and only if the corresponding theory predicate is satisfiable with respect to the bounded lengths of the string variables. For each definition d(a)⇒a (or conversely ¬d(a)⇒¬a), the solver 132 encodes the theory literal a (or ¬a) into a propositional formula (in conjunctive normal form) and distributes the variable d(a) (or ¬d(a)) to all clauses. The conjunction of the encoded definitions and the Boolean abstraction of the input formula is then given to the SAT solver 302.

In some examples, the SAT solver 302 performs the conflict-driven clause learning (CDCL(T)) process in a single step-that is, the SAT solver 302 searches for a model of the Boolean skeleton that is consistent with all (the encodings of) the predicates. Thus, if the SAT solver 302 finds a model for the formula, the input formula is also satisfiable (and thus if the SAT solver 302 returns a SAT 312 result value, a SAT result 314 is returned by the solver 132). If otherwise the formula is UNSAT (e.g., the SAT solver 302 returns an UNSAT 318 result value). then it is only UNSAT for the respective bounded lengths of the string variables in that round. In that case, the solver 132 analyzes 316 the UNSAT core produced by the SAT solver 302 to determine which predicates conflicted and led to unsatisfiability. If the bounded length of the variables involved do not exceed the upper bounds of the unsatisfied predicates, the solver 132 increases 320 the variables' length values and tries to solve the problem in a larger search space (e.g., by again generating 310 a new encoding with respect to the updated bounded lengths and invoking the SAT solver 302 on the updated encoding).

More formally, the solver 132 lets bₖ: Γ→ [symbol] denote the upper bounds valid in round k ∈ [symbol] ₁. For convenience, the solver 132 defines b₀: Γ→{1} as the constant 1-function. Thus, the solver runs n rounds with respective bounds b₁, . . . , bₙ such that for all k ∈ 0..n−1: bₖ(x)≤bₖ₊₁(x): and there is at least one x ∈ Γ with bₖ(x)<bₖ+1(x). A round ends in an incremental call to the SAT solver 302 until, in round n, the encoding with respect to bₙ is either satisfiable or it is unsatisfiable, even if increasing bounds further.

For a literal a ∈ literals(ψ) the solver uses [symbol] a [symbol] to refer to the set of clauses produced for encoding a with respect to upper bounds bₖ. Further, for rounds k, k′ with k′<k, the solver uses [symbol] a [symbol] to denote the encoding of a using upper bounds bₖ, given that [symbol] a [symbol] has already been encoded. That is, the solver ensures [symbol] a [symbol] ≡ [symbol] a [symbol] ∧ [symbol] a [symbol] holds for an incremental encoding to be correct. If the bounds are clear from the context, this can be expressed more simply by [symbol] a [symbol] . Furthermore, sometimes the solver's encoding introduces clauses that are valid only for a specific bound bₖ but become invalid in some later round bₖ′. Since an interface to a SAT solver 302 may not allow the removal of clauses, the solver 132 can introduce selector variables. Here, a selector variable is new unused a Boolean variable s whose negation ¬s is distributed over a set of clauses. For every incremental call where s is used as an assumption, the ¬s has no influence on the satisfiability of the clauses. In an incremental call where s is dropped from the assumptions, all clauses become trivially satisfiable. The solver assumes (l)_{bk(x)} to denote that the literal l is used as an assumption until the first round k′ with bₖ(x)<bₖ′(x).

To perform string variable substitutions, given a bound n and an alphabet A, the solver 132 uses a new symbol λ that is not in A, and a string s of length k less than or equal to n is encoded as s.λ^{n-k}.In this manner, string variables of length no more than n are encoded as n-character words of A ∪ {λ}. For example, at any given iteration of the solving process, the SAT solver 302 is attempting to find solutions up to the bound for a given variable. Now that the solver 132 has an alphabet and fixed length string variables, the solver 132 then converts each string variable into a set of Boolean variables. Thus, if there are n characters and there is an alphabet size of |A|, then the solver 132 uses n(|A|+1) Boolean variables per string. In some examples, the encoding of the string variables includes using a one-hot propositional encoding for each character.

For example, assume a string variable x that has been associated with a bounded length value of 5. Then, for each position in the string variable (i.e., at each of the character positions x₀, x₁, x₂, x₃, and x₄), the solver 132 introduces a set of Boolean variables and assert that exactly one variable in that set is assigned to true. And since the solver 132 has finitely bounded the length of the string variable and there is a finite alphabet, there is a finite set of possible assignments of characters to that string.

The solver 132 then encodes the constraints expressed in the formula. As indicated above, the types of constraints expressed in a formula can include, e.g., regular expressions, equalities between variables, equalities between variables and constants, prefix of constraints, suffix of constraints, substring of constraints, etc.

In some examples, the encoding of regular expression constraints (e.g., x ∈ R) involves converting the regular expression into a nondeterministic finite automaton (NFA) and optionally removing any epsilon transitions. The constraint x E R is then encoded as reachability of final states in the NFA (e.g., determining whether a string is recognized by an NFA is a reachability problem). It is noted that this process also works for negations. More formally, for a regular constraint x E R (or its negation), the solver 132 compiles a NFA M that accepts R and additionally allows λ-self-transition on each state (e.g., to allow λ substitutions). The solver 132 further includes specialized encodings for other types of constraints such as, e.g., equalities, prefix of constraints, etc.

In some examples, at circle “6,” the SAT solver 302 searches for a model that is consistent with the set of definitions. As indicated, the SAT solver intuitively performs the CDCL(T) process in a single step—that is, it searches for a model of the Boolean skeleton that is consistent with all (the encodings of) the predicates. Thus, if the SAT solver 302 finds a model for the formula, the input formula 300 is also satisfiable.

If otherwise the formula is unsatisfiable, then it is unsatisfiable only for the current bounds. At circle “7,” in some examples, the solver 132 analyzes the UNSAT core to identify which theory literals are part of an unsatisfiable subformula with respect to the current bounds. Those theory literals are analyzed to determine whether the formula is unsatisfiable regardless of what bounds are set. If the bound of the variables involved do not exceed the upper bounds of the unsatisfied predicates, the solver 132 increases the variable bounds and tries to solve the problem in a larger search space.

If it is determined to increase the bounds for one or more of the string variables, at circle “8,” the current bounds for the identified theory literals are increased. This process also involves determining an upper bound for one or more string variables, if possible. For example, an upper bound for variables can be inferred by observing that if x ∈ R has a solution, then it also has a solution h with |h(x)| less than or equal to the number of states in an NFA that accepts R. Conversely, if the SAT solver 302 does not find a solution with bound x equal to the number of states, then it can be determined that no solution exists. This idea is applied to the conjunction (or regular language intersection) of predicates that lead to the UNSAT result.

In some examples, the solver 132 collects predicates that were marked as failing in circle “7” and partitions those predicates by their equivalence class. That is, there is one set of atoms per string variable occurring in the conflicting atoms, and if an atom of the form x≐y failed (where x and y are string variables), the sets for x and y are merged into a single set. In another step, the solver 132 calculates the maximum exact upper bound for each partition (or equivalence class) in part by: calculating the power set of the partition: for each set in the power set, calculating the NFA of the intersection of all atoms contained: and finding the number of states of the largest of the NFAs.

If the conjunction of the failed atoms (per class) has a solution at all, then it also has a solution with length strictly less than the inferred maximum upper bound. Thus, once the maximum upper bound is found, the solver 132 checks which variables in the class currently have a padding strictly less than it. For those variables, the solver 132 increases their bounds for the next round. If there is no variable in the closure with a bound less than the maximum upper bound. increasing the bounds cannot render the atoms and the associated clauses satisfiable, and the solver 132 returns UNSAT (e.g., if max length 322 is reached, the solver 132 returns UNSAT result 324). If the bound of at least one variable was increased, the solver 132 backtracks to the encoding process 310 and runs the process again. In some examples, the upper bound can be provided as user input upon invoking the solver or as a default upper bound to use for multiple invocations of the solver 132.

In some examples, the loop illustrated by circles “5” (generate encoding 310), “6” (invoking the SAT solver 302), “7” (analyzing 316 an UNSAT core responsive to a determination by the SAT solver 302 that the current encoding is UNSAT 318), and “8” (update bounds 320) in FIG. 3 uses incremental SAT solving. For example, when the solver 132 produces the SAT encoding for increased bounds, only new clauses are added to the SAT solver 302 via an incremental interface. As indicated above, the process is repeated until either the solver can return SAT (e.g., SAT result 314) or it finds that further increasing the bounds cannot render the formula satisfiable, in which case it returns UNSAT (e.g., UNSAT result 324).

In some examples, the findings 144 returned by the solver 132 (or by other portfolio solver(s) 142) can be used in a variety of ways. As one example, the automated reasoning service 130 can cause display in a web-based console or other interface information about the findings to indicate to a user, e.g., one or more security or operational concerns with the current configuration of the user's policies. The findings 144 can also be used by the automated reasoning service 130, or provided to another component other service or provider network 100, and used to generate one or more recommendations for modifying a user's policies to address one or more identified security or operational concerns.

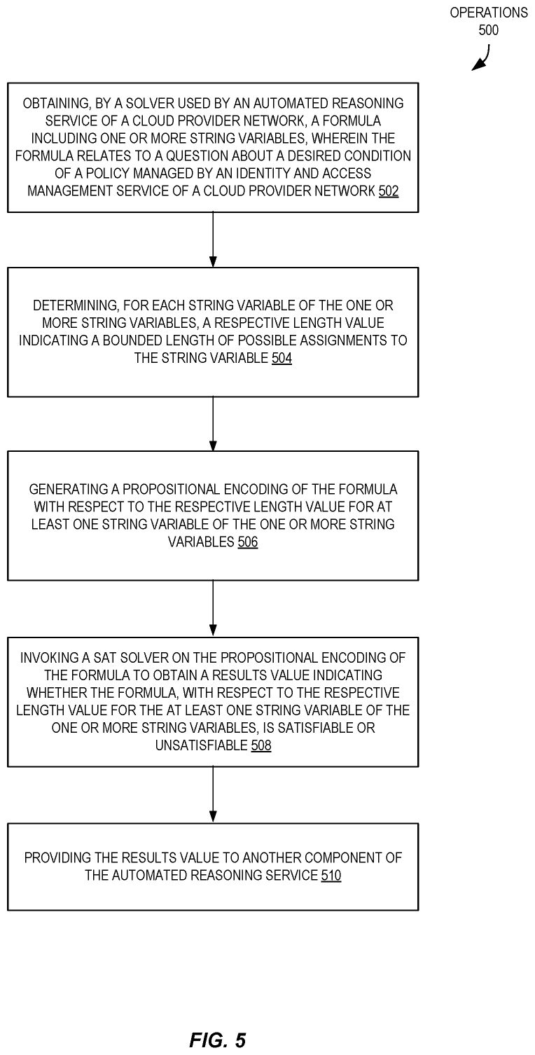

FIG. 5 is a flow diagram illustrating operations 500 of a method for using a SAT-based solver for a quantifier-free theory of strings and bit vectors to analyze policies the consequences of policies of a cloud provider network according to some examples. Some or all the operations 500 (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 500 are performed by an automated reasoning service 130 of the other figures.

The operations 500 include, at block 502, obtaining, by a solver used by an automated reasoning service of a cloud provider network, a formula including one or more string variables, wherein the formula relates to a question about a desired condition of a policy managed by an identity and access management service of a cloud provider network.

The operations 500 further include, at block 504, determining, for each string variable of the one or more string variables, a respective length value indicating a bounded length of possible assignments to the string variable.

The operations 500 further include, at block 506, generating a propositional encoding of the formula with respect to the respective length value for at least one string variable of the one or more string variables.

The operations 500 further include, at block 508, invoking a SAT solver on the propositional encoding of the formula to obtain a results value indicating whether the formula, with respect to the respective length value for the at least one string variable of the one or more string variables, is satisfiable or unsatisfiable.

The operations 500 further include, at block 510, providing the results value to another component of the automated reasoning service.

In some examples, the operations 500 further include determining an alphabet for the propositional encoding of each atomic formula within the first-order logic formula, wherein the alphabet includes characters occurring in the first-order logic formula and an extra character (e.g., per variable): and wherein generating the propositional encoding of each atomic formula within the first-order logic formula is performed with respect to the alphabet.

In some examples, the result value indicates that the formula is unsatisfiable, and wherein the operations further include: obtaining, from the SAT solver, an unsatisfiable core of the formula, wherein the unsatisfiable core of the formula includes a subset of atomic formulas of the formula: identifying, within the unsatisfiable core, a subset of the one or more string variables in the formula: determining, for each string variable of the subset of the one or more string variables, an updated bounded length by increasing a respective bounded length currently assigned to the string variable: obtaining an updated propositional encoding of the formula based on the respective updated bounded length for each string variable of the subset of the one or more string variables: and invoking the SAT solver on the updated propositional encoding of the formula.

In some examples, a string variable of the one or more string variables is part of an atomic formula including a regular expression constraint, and wherein the operations further include: translating the atomic formula including the regular expression constraint into a nondeterministic finite automaton (possibly without epsilon transitions).

In some examples, determining the respective length value for a string variable includes iterating over the string predicates for a string variable and determining a length of a smallest word that satisfies the string predicate.

In some examples, invoking the SAT solver on the updated propositional encoding of the formula includes using incremental solving functionality of the SAT solver.

In some examples, the result value indicates that the first-order logic formula is unsatisfiable, and the operations 500 further include obtaining, from the SAT solver, an unsatisfiable core of the formula, wherein the unsatisfiable core of the formula includes a subset of the atomic formulas of the first-order logic formula: identifying, within the unsatisfiable core, a subset of the one or more string variables in the first-order logic formula: determining, for each string variable of the subset, that an upper bound has been reached for the each string variable of the subset: and determining that the first-order logic formula is unsatisfiable.

In some examples, the question about the desired condition of the policy includes at least one of: determining whether public write access is permitted on a computing resource, determining whether unencrypted writes are permitted on a computing resources, determining whether public read access is permitted on a computing resource, or determining whether Secure Socket Layer (SSL) requests are required to access a computing resource, or comparing a permissiveness of two policies relative to one another.

In some examples, the operations further include receiving input indicating an initial length value to use for one or more string variables in the formula: and wherein determining the respective length value indicating the bounded length of possible assignments to a string variable is based on the input indicating the initial length value.

In some examples, the operations 500 further include causing display of information indicating whether the policy conforms to the desired condition of the policy.

In some examples, the operations 500 further include generating, based on the results value, a recommendation related to the policy based on the results value, wherein the recommendation identifies a potential modification to the policy: and causing display of the recommendation.

In some examples, the operations 500 further include receiving user-specified input indicating the upper bound.

In some examples, the operations 500 further include receiving user-specified input indicating the upper bound to be used by the solver.

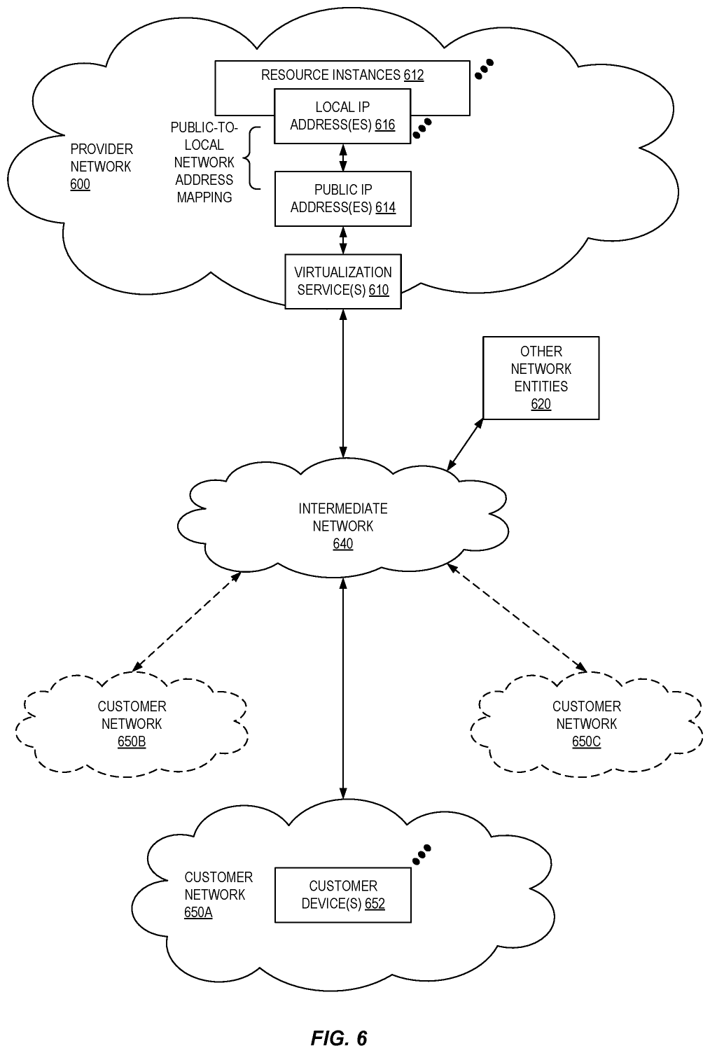

FIG. 6 illustrates an example provider network (or “service provider system”) environment according to some examples. A provider network 600 can provide resource virtualization to customers via one or more virtualization services 610 that allow customers to purchase, rent, or otherwise obtain instances 612 of virtualized resources, including but not limited to computation and storage resources, implemented on devices within the provider network or networks in one or more data centers. Local Internet Protocol (IP) addresses 616 can be associated with the resource instances 612: the local IP addresses are the internal network addresses of the resource instances 612 on the provider network 600. In some examples, the provider network 600 can also provide public IP addresses 614 and/or public IP address ranges (e.g., Internet Protocol version 4 (IPv4) or Internet Protocol version 6 (IPv6) addresses) that customers can obtain from the provider 600.

Conventionally, the provider network 600, via the virtualization services 610, can allow a customer of the service provider (e.g., a customer that operates one or more customer networks 650A-650C (or “client networks”) including one or more customer device(s) 652) to dynamically associate at least some public IP addresses 614 assigned or allocated to the customer with particular resource instances 612 assigned to the customer. The provider network 600 can also allow the customer to remap a public IP address 614, previously mapped to one virtualized computing resource instance 612 allocated to the customer, to another virtualized computing resource instance 612 that is also allocated to the customer. Using the virtualized computing resource instances 612 and public IP addresses 614 provided by the service provider, a customer of the service provider such as the operator of the customer network(s) 650A-650C can, for example, implement customer-specific applications and present the customer's applications on an intermediate network 640), such as the Internet. Other network entities 620 on the intermediate network 640 can then generate traffic to a destination public IP address 614 published by the customer network(s) 650A-650C: the traffic is routed to the service provider data center, and at the data center is routed, via a network substrate, to the local IP address 616 of the virtualized computing resource instance 612 currently mapped to the destination public IP address 614. Similarly, response traffic from the virtualized computing resource instance 612 can be routed via the network substrate back onto the intermediate network 640 to the source entity 620.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses: instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances: these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 600: a customer can then assign their allocated public IP addresses to particular resource instances allocated to the customer. These public IP addresses can be referred to as customer public IP addresses, or simply customer IP addresses. Instead of being assigned by the provider network 600 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

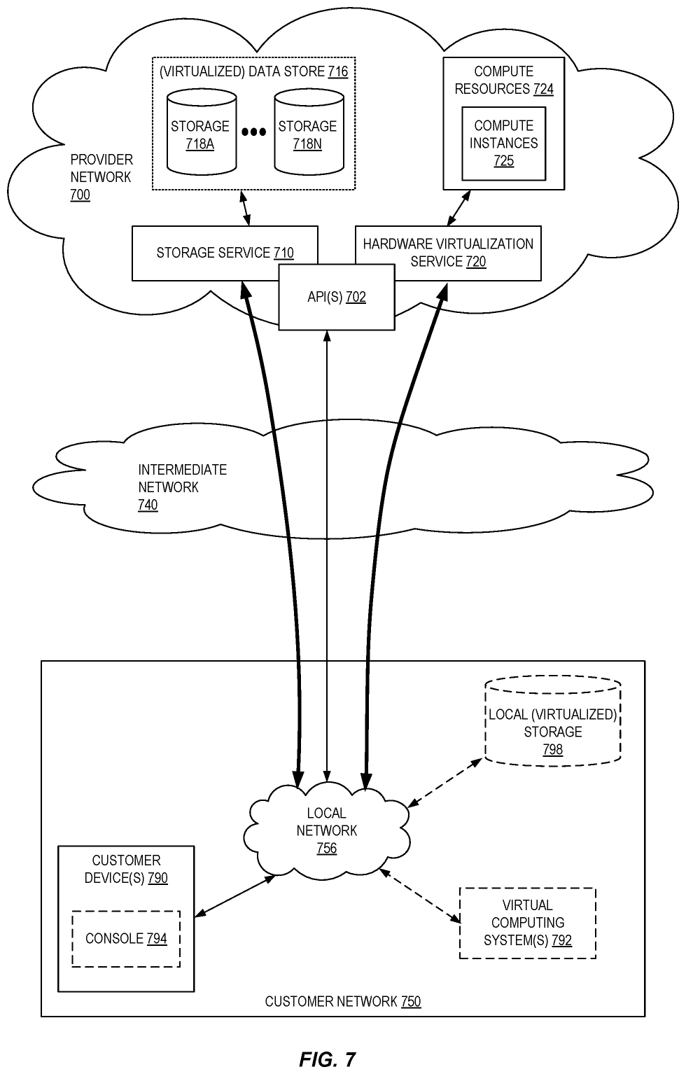

FIG. 7 is a block diagram of an example provider network environment that provides a storage service and a hardware virtualization service to customers, according to some examples. A hardware virtualization service 720 provides multiple compute resources 724 (e.g., compute instances 725, such as VMs) to customers. The compute resources 724 can, for example, be provided as a service to customers of a provider network 700 (e.g., to a customer that implements a customer network 750). Each computation resource 724 can be provided with one or more local IP addresses. The provider network 700 can be configured to route packets from the local IP addresses of the compute resources 724 to public Internet destinations, and from public Internet sources to the local IP addresses of the compute resources 724.

The provider network 700 can provide the customer network 750, for example coupled to an intermediate network 740 via a local network 756, the ability to implement virtual computing systems 792 via the hardware virtualization service 720 coupled to the intermediate network 740) and to the provider network 700. In some examples, the hardware virtualization service 720 can provide one or more APIs 702, for example a web services interface, via which the customer network 750) can access functionality provided by the hardware virtualization service 720, for example via a console 794 (e.g., a web-based application, standalone application, mobile application, etc.) of a customer device 790. In some examples, at the provider network 700, each virtual computing system 792 at the customer network 750 can correspond to a computation resource 724 that is leased, rented, or otherwise provided to the customer network 750.

From an instance of the virtual computing system(s) 792 and/or another customer device 790 (e.g., via console 794), the customer can access the functionality of a storage service 710, for example via the one or more APIs 702, to access data from and store data to storage resources 718A-718N of a virtual data store 716 (e.g., a folder or “bucket,” a virtualized volume, a database. etc.) provided by the provider network 700. In some examples, a virtualized data store gateway (not shown) can be provided at the customer network 750 that can locally cache at least some data. for example frequently accessed or critical data, and that can communicate with the storage service 710 via one or more communications channels to upload new or modified data from a local cache so that the primary store of data (the virtualized data store 716) is maintained. In some examples. a user, via the virtual computing system 792 and/or another customer device 790, can mount and access virtual data store 716 volumes via the storage service 710 acting as a storage virtualization service, and these volumes can appear to the user as local (virtualized) storage 798.

While not shown in FIG. 7, the virtualization service(s) can also be accessed from resource instances within the provider network 700 via the API(s) 702. For example, a customer. appliance service provider, or other entity can access a virtualization service from within a respective virtual network on the provider network 700 via the API(s) 702 to request allocation of one or more resource instances within the virtual network or within another virtual network.

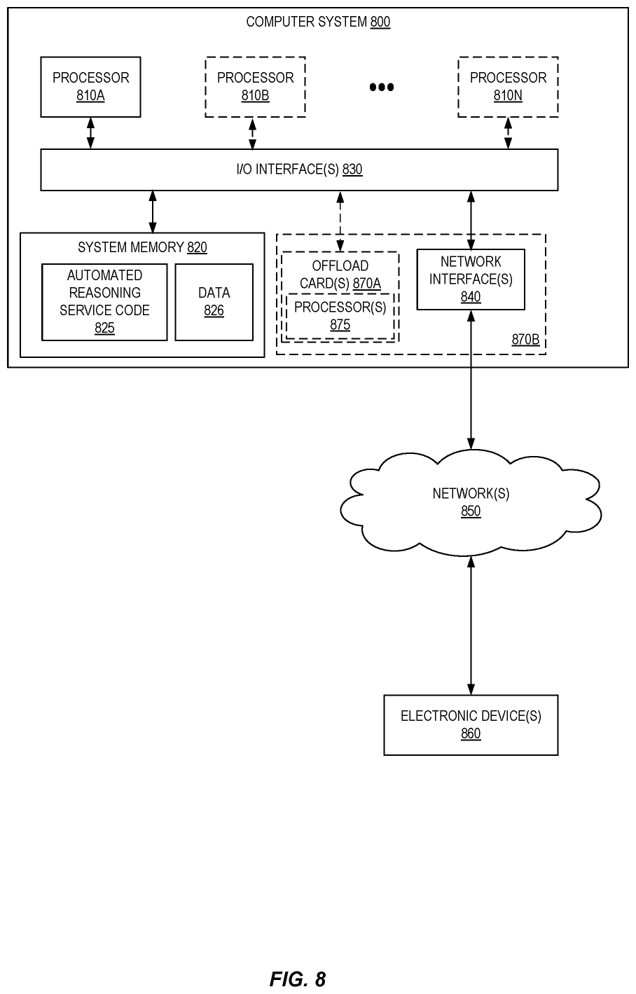

In some examples, a system that implements a portion or all of the techniques described herein can include a general-purpose computer system, such as the computer system 800 illustrated in FIG. 8, that includes, or is configured to access, one or more computer-accessible media. In the illustrated example, the computer system 800 includes one or more processors 810) coupled to a system memory 820 via an input/output (I/O) interface 830. The computer system 800 further includes a network interface 840 coupled to the I/O interface 830. While FIG. 8 shows the computer system 800 as a single computing device, in various examples the computer system 800 can include one computing device or any number of computing devices configured to work together as a single computer system 800.

In various examples, the computer system 800 can be a uniprocessor system including one processor 810, or a multiprocessor system including several processors 810 (e.g., two, four. eight, or another suitable number). The processor(s) 810 can be any suitable processor(s) capable of executing instructions. For example, in various examples, the processor(s) 810 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 810 can commonly, but not necessarily, implement the same ISA.

The system memory 820 can store instructions and data accessible by the processor(s) 810. In various examples, the system memory 820 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 820 as automated reasoning service code 825 (e.g., executable to implement, in whole or in part, the automated reasoning service 130) and data 826.

In some examples, the I/O interface 830 can be configured to coordinate I/O traffic between the processor 810, the system memory 820, and any peripheral devices in the device. including the network interface 840 and/or other peripheral interfaces (not shown). In some examples, the I/O interface 830 can perform any necessary protocol, timing, or other data transformations to convert data signals from one component (e.g., the system memory 820) into a format suitable for use by another component (e.g., the processor 810). In some examples, the I/O interface 830 can include support for devices attached through various types of peripheral buses. such as a variant of the Peripheral Component Interconnect (PCI) bus standard or the Universal Serial Bus (USB) standard, for example. In some examples, the function of the I/O interface 830 can be split into two or more separate components, such as a north bridge and a south bridge, for example. Also, in some examples, some or all of the functionality of the I/O interface 830, such as an interface to the system memory 820, can be incorporated directly into the processor 810.

The network interface 840 can be configured to allow data to be exchanged between the computer system 800 and other devices 860 attached to a network or networks 850, such as other computer systems or devices as illustrated in FIG. 1, for example. In various examples, the network interface 840) can support communication via any suitable wired or wireless general data networks, such as types of Ethernet network, for example. Additionally, the network interface 840) can support communication via telecommunications/telephony networks, such as analog voice networks or digital fiber communications networks, via storage area networks (SANS), such as Fibre Channel SANs, and/or via any other suitable type of network and/or protocol.

In some examples, the computer system 800 includes one or more offload cards 870A or 870B (including one or more processors 875, and possibly including the one or more network interfaces 840) that are connected using the I/O interface 830 (e.g., a bus implementing a version of the Peripheral Component Interconnect-Express (PCI-E) standard, or another interconnect such as a QuickPath interconnect (QPI) or UltraPath interconnect (UPI)). For example, in some examples the computer system 800 can act as a host electronic device (e.g., operating as part of a hardware virtualization service) that hosts compute resources such as compute instances, and the one or more offload cards 870A or 870B execute a virtualization manager that can manage compute instances that execute on the host electronic device. As an example, in some examples the offload card(s) 870A or 870B can perform compute instance management operations, such as pausing and/or un-pausing compute instances, launching and/or terminating compute instances. performing memory transfer/copying operations, etc. These management operations can, in some examples, be performed by the offload card(s) 870A or 870B in coordination with a hypervisor (e.g., upon a request from a hypervisor) that is executed by the other processors 810A-810N of the computer system 800. However, in some examples the virtualization manager implemented by the offload card(s) 870A or 870B can accommodate requests from other entities (e.g., from compute instances themselves), and can not coordinate with (or service) any separate hypervisor.

In some examples, the system memory 820 can be one example of a computer-accessible medium configured to store program instructions and data as described above. However, in other examples, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computer system 800 via the I/O interface 830. A non-transitory computer-accessible storage medium can also include any volatile or non-volatile media such as RAM (e.g., SDRAM, double data rate (DDR) SDRAM. SRAM, etc.), read only memory (ROM). etc., that can be included in some examples of the computer system 800 as the system memory 820 or another type of memory. Further, a computer-accessible medium can include transmission media or signals such as electrical, electromagnetic, or digital signals, conveyed via a communication medium such as a network and/or a wireless link, such as can be implemented via the network interface 840).

Various examples discussed or suggested herein can be implemented in a wide variety of operating environments, which in some cases can include one or more user computers. computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems. and/or other devices capable of communicating via a network.

Most examples use at least one network that would be familiar to those skilled in the art for supporting communications using any of a variety of widely-available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers. File Transfer Protocol (FTP) servers. Common Gateway Interface (CGI) servers, data servers. Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python. PHP, or TCL, as well as combinations thereof. The server(s) can also include database servers, including without limitation those commercially available from Oracle(R), Microsoft(R), Sybase(R), IBM(R), etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices. each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code. can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM. ROM. Electrically Erasable Programmable Read-Only Memory (EEPROM), flash memory or other memory technology. Compact Disc-Read Only Memory (CD-ROM). Digital Versatile Disk (DVD) or other optical storage, magnetic cassettes, magnetic tape. magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 718A-718N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
generating, by an automated reasoning service of a cloud provider network, a first-order logic formula, wherein the first-order logic formula is generated based on a policy managed by an identity and access management service of the cloud provider network and a rule, wherein the rule expresses a desired condition of the policy, and wherein the first-order logic formula includes one or more string variables;
generating a Boolean abstraction of the first-order logic formula, wherein the Boolean abstraction of the first-order logic formula includes one or more Boolean variables each representing an atomic formula of the first-order logic formula;
determining, for each string variable of the one or more string variables, a respective length value indicating a bounded length of possible string assignments to the string variable;
generating a propositional encoding of each atomic formula within the first-order logic formula based on the respective length value for each string variable;
invoking a SAT solver on the Boolean abstraction of the first-order logic formula and the propositional encoding of each atomic formula in the first-order logic formula to obtain a result value indicating whether the first-order logic formula, with respect to the respective length value for each string variable, is satisfiable or unsatisfiable;
determining, based on the result value, whether the policy conforms to the desired condition of the policy expressed by the rule; and
causing display of information indicating whether the policy conforms to the desired condition of the policy expressed by the rule.

2. The computer-implemented method of claim 1, wherein the result value indicates that the first-order logic formula, with respect to the respective length value for each string variable, is unsatisfiable, and wherein the method further comprises:
obtaining, from the SAT solver, an unsatisfiable core of the first-order logic formula, wherein the unsatisfiable core of the first-order logic formula includes a subset of atomic formulas of the first-order logic formula;
identifying, within the unsatisfiable core, a subset of the one or more string variables in the first-order logic formula;
determining, for each string variable of the subset of the one or more string variables, an updated bounded length by increasing a respective bounded length currently assigned to the string variable;
obtaining an updated propositional encoding of the first-order logic formula based on the respective updated bounded length for each string variable of the subset of the one or more string variables; and
invoking the SAT solver on the updated propositional encoding of the first-order logic formula.

3. The computer-implemented method of claim 1, further comprising:
determining an alphabet for the propositional encoding of each atomic formula within the first-order logic formula, wherein the alphabet includes characters occurring in the first-order logic formula and an extra character; and
wherein generating the propositional encoding of each atomic formula within the first-order logic formula is performed with respect to the alphabet.

4. A computer-implemented method comprising:
obtaining, by a solver used by an automated reasoning service of a cloud provider network, a formula including one or more string variables, wherein the formula relates to a question about a desired condition of a policy managed by an identity and access management service of a cloud provider network;
determining, for at least one string variable of the one or more string variables, a respective length value indicating a bounded length of possible assignments to the string variable;
generating a propositional encoding of the formula with respect to the respective length value for at least one string variable of the one or more string variables;
invoking a SAT solver on the propositional encoding of the formula to obtain a results value indicating whether the formula, with respect to the respective length value for the at least one string variable of the one or more string variables, is satisfiable or unsatisfiable; and
providing the results value to another component of the automated reasoning service.

5. The computer-implemented method of claim 4, wherein the result value indicates that the formula is unsatisfiable, and wherein the method further comprises:
obtaining, from the SAT solver, an unsatisfiable core of the formula, wherein the unsatisfiable core of the formula includes a subset of atomic formulas of the formula;
identifying, within the unsatisfiable core, a subset of the one or more string variables in the formula;
determining, for each string variable of the subset of the one or more string variables, an updated bounded length by increasing a respective bounded length currently assigned to the string variable;
obtaining an updated propositional encoding of the formula based on the respective updated bounded length for each string variable of the subset of the one or more string variables; and
invoking the SAT solver on the updated propositional encoding of the formula.

6. The computer-implemented method of claim 4, further comprising:
determining an alphabet for the propositional encoding of each atomic formula within the formula, wherein the alphabet includes characters occurring in the formula and an extra character; and
wherein generating the propositional encoding of each atomic formula within the formula is performed with respect to the alphabet.

7. The computer-implemented method of claim 4, wherein a string variable of the one or more string variables is part of an atomic formula including a regular expression constraint, and wherein the method further comprises translating the atomic formula including the regular expression constraint into a nondeterministic finite automaton.

8. The computer-implemented method of claim 4, wherein determining the respective length value for a string variable includes iterating over the string predicates for a string variable and determining a length of a smallest word that satisfies the string predicate.

9. The computer-implemented method of claim 5, wherein invoking the SAT solver on the updated propositional encoding of the formula includes using incremental solving functionality of the SAT solver.

10. The computer-implemented method of claim 4, wherein the result value indicates that the formula is unsatisfiable, and wherein the method further comprises:
obtaining, from the SAT solver, an unsatisfiable core of the formula, wherein the unsatisfiable core of the formula includes a subset of atomic formulas of the formula;
identifying, within the unsatisfiable core, a subset of the one or more string variables in the formula;
determining, for each string variable of the subset, that an upper bound has been reached for the each string variable of the subset; and
determining that the formula is unsatisfiable.

11. The computer-implemented method of claim 4, wherein the question about the desired condition of the policy includes at least one of: determining whether public write access is permitted on a computing resource, determining whether unencrypted writes are permitted on a computing resource, determining whether public read access is permitted on a computing resource, or determining whether Secure Socket Layer (SSL) requests are required to access a computing resource, or comparing a permissiveness of two policies relative to one another.

12. The computer-implemented method of claim 4, further comprising:
receiving input indicating an initial length value to use for one or more string variables in the formula; and
wherein determining the respective length value indicating the bounded length of possible assignments to a string variable is based on the input indicating the initial length value.

13. The computer-implemented method of claim 10, further comprising receiving user-specified input indicating the upper bound to be used by the solver.

14. The computer-implemented method of claim 4, further comprising causing display of information indicating whether the policy conforms to the desired condition of the policy.

15. The computer-implemented method of claim 4, further comprising:
generating, based on the results value, a recommendation related to the policy based on the results value, wherein the recommendation identifies a potential modification to the policy; and
causing display of the recommendation.

16. A system comprising:
a first one or more electronic devices to implement an automated reasoning service in a multi-tenant provider network, wherein the automated reasoning service includes instructions that upon execution cause the automated reasoning service to:
generate a first-order logic formula, wherein the first-order logic formula is generated based on a policy managed by an identity and access management service of a cloud provider network and a rule, wherein the rule expresses a desired condition of the policy, and wherein the first-order logic formula includes one or more string variables; and
a second one or more electronic devices to implement an automated reasoning solver in the multi-tenant provider network, wherein the automated reasoning solver includes instructions that upon execution cause the automated reasoning service to:
generate a Boolean abstraction of the first-order logic formula, wherein the Boolean abstraction of the first-order logic formula includes one or more Boolean variables each representing an atomic formula of the first-order logic formula;
determine, for each string variable of the one or more string variables, a respective length value indicating a bounded length of possible string assignments to the string variable;
generate a propositional encoding of each atomic formula within the first-order logic formula based on the respective length value for each string variable;
invoke a SAT solver on the Boolean abstraction of the first-order logic formula and the propositional encoding of each atomic formula in the first-order logic formula to obtain a result value indicating whether the first-order logic formula, with respect to the respective length value for each string variable, is satisfiable or unsatisfiable;
determine, based on the result value, whether the policy conforms to the desired condition of the policy expressed by the rule; and
cause display of information indicating whether the policy conforms to the desired condition of the policy expressed by the rule.

17. The system of claim 16, wherein the result value indicates that the first-order logic formula, with respect to the respective length value for each string variable, is unsatisfiable, and wherein the automated reasoning solver further includes instructions that upon execution cause the automated reasoning service to:
obtaining, from the SAT solver, an unsatisfiable core of the first-order logic formula, wherein the unsatisfiable core of the first-order logic formula includes a subset of atomic formulas of the first-order logic formula;
identifying, within the unsatisfiable core, a subset of the one or more string variables in the first-order logic formula;
determining, for each string variable of the subset of the one or more string variables, an updated bounded length by increasing a respective bounded length currently assigned to the string variable;
obtaining an updated propositional encoding of the first-order logic formula based on the respective updated bounded length for each string variable of the subset of the one or more string variables; and
invoking the SAT solver on the updated propositional encoding of the first-order logic formula.

18. The system of claim 16, wherein the automated reasoning solver further includes instructions that upon execution cause the automated reasoning service to:
determining an alphabet for the propositional encoding of each atomic formula within the first-order logic formula, wherein the alphabet includes characters occurring in the first-order logic formula and an extra character; and
wherein generating the propositional encoding of each atomic formula within the first-order logic formula is performed with respect to the alphabet.

19. The system of claim 16, wherein a string variable of the one or more string variables is part of an atomic formula including a regular expression constraint, and wherein the automated reasoning solver further includes instructions that upon execution cause the automated reasoning service to:
translating the atomic formula including the regular expression constraint into a nondeterministic finite automaton.

20. The system of claim 16, wherein determining the respective length value for a string variable includes iterating over the string predicates for a string variable and determining a length of a smallest word that satisfies the string predicate.
